(19) United States
(12) Patent Application Publication
(10) Pub. No.: US 2024/0073753 A1
(43) Pub. Date: Feb. 29, 2024

(54) METHODS AND APPARATUSES FOR CONFIGURATION REPLACE OPERATION IN CPAC PROCEDURE

(71) Applicant: LENOVO (BEIJING) LIMITED, Beijing (CN)

(72) Inventors: Congchi Zhang, Shanghai (CN); Lianhai Wu, Beijing (CN); Mingzeng Dai, Shanghai (CN); Le Yan, Shanghai (CN)

(21) Appl. No.: 18/549,121

(22) PCT Filed: Mar. 4, 2021
(86) PCT No.: PCT/CN2021/079062

§ 371 Date: Sep. 5, 2023

(51) Int. Cl. H04W 36/00

(52) U.S. Cl. CPC H04W 36/0069; H04W 36/0061; H04W 92/20

(57) ABSTRACT

Embodiments of the present application relate to methods and apparatuses for a configuration replace operation in a conditional primary cell of a secondary cell group (PSCell) addition and change (CPAC) procedure under a 3rd Generation Partnership Project (3GPP) 5G system or the like. According to an embodiment of the present application, a method performed by a radio access network (RAN) node can comprises: receiving configuration information relating to a CPAC procedure; and in response to the configuration information relating to the CPAC procedure being modified, communicating the modified configuration information with another RAN node via a Xn interface or a X2 interface.

### TECHNICAL FIELD

Embodiments of the present application generally relate to wireless communication technology, especially to methods and apparatuses for a configuration replace operation in a conditional primary cell of a secondary cell group (PSCell) addition and change (CPAC) procedure.

### BACKGROUND

Next generation radio access network (NG-RAN) supports a multi-radio dual connectivity (MR-DC) operation. In a MR-DC scenario, a user equipment (UE) with multiple transceivers may be configured to utilize resources provided by two different nodes connected via non-ideal backhauls. Wherein one node may provide new radio (NR) access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, Xn interface as specified in 3rd Generation Partnership Project (3GPP) standard documents), and at least the MN is connected to the core network.

According to agreements of 3GPP standard documents, a CPAC procedure is defined as a PSCell addition or change that is executed by a UE when execution condition(s) is met. A UE starts evaluating the execution condition(s) upon receiving CPAC configuration information, and stops evaluating the execution condition(s) once a PSCell addition procedure and/or a PSCell change procedure is triggered. Currently, in a 3GPP 5G system or network, details of a mechanism for a configuration replace operation in a CPAC procedure in a MR-DC scenario have not been discussed in 3GPP 5G technology yet.

### SUMMARY

Some embodiments of the present application provide a method for wireless communications. The method may be performed by a radio access network (RAN) node, e.g., a MN, a source SN, or a target SN in a MR-DC scenario. The method comprises: receiving configuration information relating to a CPAC procedure; and in response to the configuration information relating to the CPAC procedure being modified, communicating the modified configuration information with another RAN node via a Xn interface or a X2 interface.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a RAN node.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary flowchart of a method for communicating modified configuration information relating to a CPAC procedure between RAN nodes in accordance with some embodiments of the present application;

FIG. 3 illustrates an exemplary flowchart of a target SN triggered CPAC replace operation in a conditional PSCell addition (CPA) procedure in accordance with some embodiments of the present application;

FIG. 4 illustrates an exemplary flowchart of a target SN triggered CPAC replace operation in a MN initiated inter SN conditional PSCell change (CPC) procedure in accordance with some embodiments of the present application;

FIG. 5 illustrates an exemplary flowchart of a target SN triggered CPAC replace operation in a SN initiated CPC procedure in accordance with some embodiments of the present application;

FIG. 6 illustrates a further flowchart of a target SN triggered CPAC replace operation in a CPA procedure based on a PSCell cancel message in accordance with some embodiments of the present application;

FIG. 7 illustrates an exemplary flowchart of a target SN triggered CPAC replace operation in a MN initiated CPC procedure based on a PSCell cancel message in accordance with some embodiments of the present application;

FIG. 8 illustrates an exemplary flowchart of a target SN triggered CPAC replace operation in a SN initiated CPC procedure based on a PSCell cancel message in accordance with some embodiments of the present application;

FIG. 9 illustrates an exemplary flowchart of a MN triggered CPAC replace operation in a CPA procedure based on a SN modification request message in accordance with some embodiments of the present application;

FIG. 10 illustrates a further flowchart of a MN triggered CPAC replace operation in a CPA procedure based on a PSCell cancel message in accordance with some embodiments of the present application;

FIG. 11 illustrates an exemplary flowchart of a MN triggered CPAC replace operation in a MN initiated CPC procedure based on a SN modification request message in accordance with some embodiments of the present application;

FIG. 12 illustrates a further flowchart of a MN triggered CPAC replace operation in a MN initiated CPC procedure based on a PSCell cancel message in accordance with some embodiments of the present application;

FIG. 13 illustrates an exemplary flowchart of a source SN triggered CPAC replace operation in a SN initiated CPC procedure based on a SN modification request message in accordance with some embodiments of the present application;

FIG. 14 illustrates a further exemplary flowchart of a source SN triggered CPAC replace operation in a SN initiated CPC procedure based on a PSCell cancel message in accordance with some embodiments of the present application; and

FIG. 15 illustrates an exemplary block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

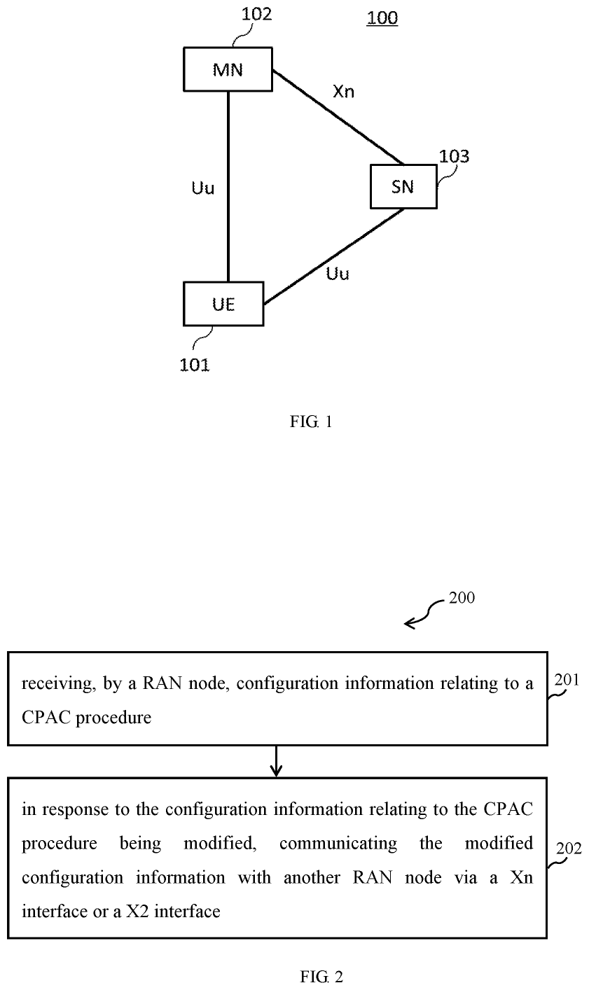

FIG. 1 illustrates a schematic diagram of a wireless communication system in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, the Xn interface as specified in 3GPP standard documents. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a master cell group (MCG). The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a secondary cell group (SCG). The SCG may refer to a group of serving cells associated with SN 103, and may include a primary secondary cell (PSCell) and optionally one or more secondary cells (SCells). The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

Generally, during a SN change procedure in a MR-DC scenario, a source SN is changed to a target SN. A SN change procedure may be initiated by a MN or a SN. In accordance with 3GPP standard document TS37.340, a MN initiated SN change procedure is used to transfer a UE context from a source SN to a target SN and to change the SCG configuration in a UE from one SN to another SN. A SN initiated SN change procedure is used to transfer a UE context from a source SN to a target SN and to change the SCG configuration in a UE from one SN to another SN. 3GPP standard document TS37.340 also specifies a SN addition procedure and a SN modification procedure. A SN modification procedure may be a MN initiated SN modification procedure or a SN initiated SN modification procedure with a MN involvement.

Currently, according to 3GPP standard documents, agreements of a conditional PSCell addition (CPA) procedure and an inter-SN conditional PSCell change (CPC) procedure are as follows.

In a CPA procedure:
1. A MN could initiate a CPA procedure by sending a SN addition request message to multiple candidate target SNs. In the SN addition request message, the MN could indicate a list of cell(s) that could be used as PSCell(s), e.g., cells 1, 2, 3, . . . and 10.
2. Candidate target SN(s) selects a number of cells from the list of cell(s) provided by the MN to be prepared as candidate PSCell(s), e.g., cells 1, 2, 3, . . . and 5. Candidate target SN(s) will then reply a SN addition request acknowledge message. The SN addition request acknowledge message may contain a RRC reconfiguration message that provides a UE with SN RRC reconfiguration to be used upon an execution of the CPA procedure and the UE accesses to the corresponding target SN.
3. A MN generates a MN RRC reconfiguration message. The MN RRC reconfiguration message may contain a RRC conditional reconfiguration element, and the RRC conditional reconfiguration element consists of execution condition(s) (generated by the MN) and a SN RRC reconfiguration message (generated by the candidate target SN). The MN sends the generated MN RRC reconfiguration message to the UE.
4. Upon receiving the CPA related RRC reconfiguration message, the UE starts evaluating whether the execution condition(s) is fulfilled (e.g., if the measured link quality of one candidate target SN is better than a threshold). Upon the fulfillment of the execution condition(s), the UE starts accessing the corresponding target SN.

In an inter-SN CPC procedure:
1. An inter-SN CPC procedure can be either initiated by a MN or a source SN. The source SN could initiate the inter-SN CPC procedure by sending a SN change required message to the MN, and the SN change required message contains inter-SN CPC related information. Upon receiving the SN change required message triggering the inter-SN CPC procedure, or upon the MN initiating the inter-SN CPC procedure, the MN sends a SN addition request message to multiple candidate target SNs.
2. Candidate target SN(s) may reply a SN addition request acknowledge message and access to the corresponding target SN. The SN addition request acknowledge message contains a RRC reconfiguration message that provides a UE with SN RRC reconfiguration to be used upon an execution of the inter-SN CPC procedure.
3. The MN generates a MN RRC reconfiguration message. The MN RRC reconfiguration message contains a RRC conditional reconfiguration element, and the RRC conditional reconfiguration element consists of execution condition(s) (generated by the MN) and a SN RRC reconfiguration message (generated by the candidate target SN). The MN sends the generated MN RRC reconfiguration message to the UE.
4. Upon receiving the CPC related RRC reconfiguration message, the UE starts evaluating whether the execution condition(s) is fulfilled (e.g., if the measured link quality of one candidate target SN is better than a threshold). Upon the fulfillment of the execution condition(s), the UE starts accessing the corresponding target SN.

According to agreements of 3GPP Release 17, a CPA procedure and an inter-SN CPC procedure are going to be supported. However, details regarding a configuration replace operation in a CPAC procedure have not been discussed in 3GPP 5G technology yet. Some embodiments of the present application provide a mechanism for implementing a configuration replace operation in a CPAC procedure in a MR-DC scenario in 3GPP 5G system or the like. A configuration replace operation in a CPAC procedure may also be named as a replace operation in a CPAC procedure, a CPAC replace operation, a CPAC replace procedure, a configuration modification operation in a CPAC procedure, a modification operation in a CPAC procedure, a CPAC modification operation, a CPAC modification procedure, or the like.

In particular, a CPAC procedure can be used to prepare multiple candidate PSCells within the same target SN. A CPAC replace operation means a modification to previously configured CPAC preparation procedure. For example, a CPAC replace operation is an operation to replace an existing configuration of one or more PSCells. Some embodiments of the present application design information element(s) within the Xn message in a way to support a flexible CAPC replace operation.

In a CPAC procedure, a MN or a source SN might indicate a maximum or suggested total number of PSCells that can be or shall be prepared by a target SN. If a total number of prepared PSCells by one candidate target SN is less than an expected number, other candidate target SN(s) can prepare more PSCells, but it is unclear how different RAN nodes coordinate to modify the total number of PSCells that can be prepared by candidate target SN(s). Some embodiments of the present application ensure that a total number of overall prepared PSCells is less than a maximum value decided by the initiating RAN node (e.g., a MN). For a SN initiated inter-SN CPC procedure, some embodiments of the present application ensure a proper inter-SN CPC replace operation, e.g., to modify the related execution condition(s) or to modify the related SN measurement configuration, and ensure that a source SN may know PSCell(s) prepared by the candidate target SN(s).

Some embodiments of the present application provide a mechanism to support a CPAC replace procedure for following scenarios: a CPA procedure; a MN initiated CPC procedure; and a SN initiated CPC procedure. In these embodiments, a CPAC replace procedure could be triggered by either a MN, a source SN, or a target SN. These embodiments may include adding new information element(s) in existing Xn and/or X2 messages to support the CPAC replace procedure, or introducing new Xn and/or X2 messages to support the CPAC replace procedure. As such, the coordination between involved RAN nodes, e.g., a MN, a source SN, and a target SN, can be efficiently conducted. More details regarding the embodiments of the present application will be illustrated in the following text in combination with the appended drawings.

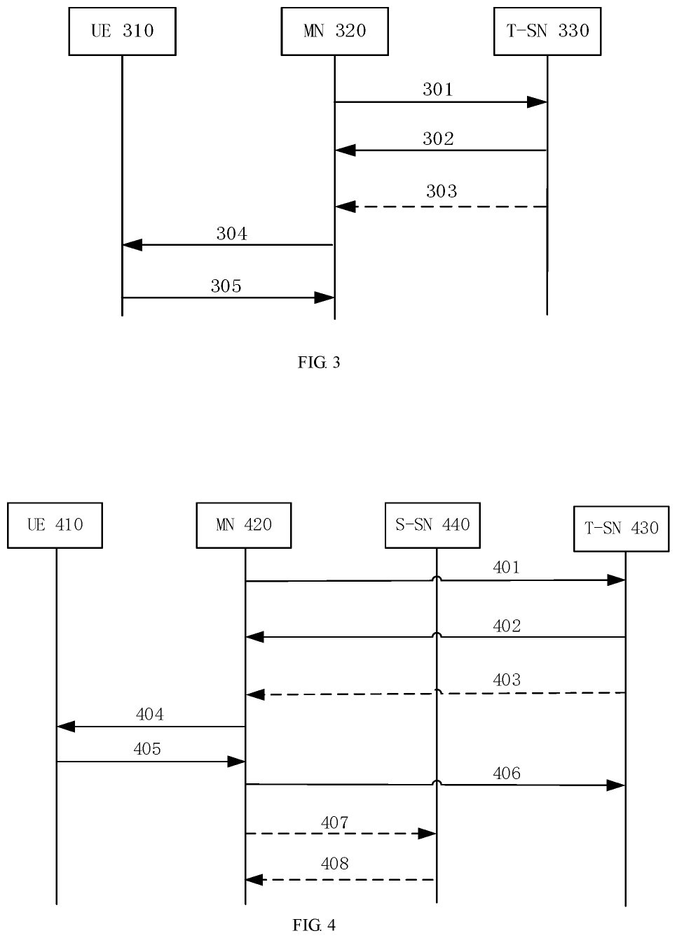

FIG. 2 illustrates an exemplary flowchart of a method for communicating modified configuration information relating to a CPAC procedure between RAN nodes in accordance with some embodiments of the present application. The exemplary method 200 in the embodiments of FIG. 2 may be performed by a RAN node, for example:
a MN (e.g., MN 320, MN 420, MN 520, MN 620, MN 720, MN 820, MN 920, MN 1020, MN 1120, MN 1220, MN 1320, or MN 1420 as illustrated and shown in any of FIGS. 3-14, respectively); or
a target SN during a SN addition procedure or a SN change procedure (e.g., T-SN 330, T-SN 430, T-SN 530, T-SN 630, T-SN 730, T-SN 830, T-SN 930, T-SN 1030, T-SN 1130, T-SN 1230, T-SN 1330, or T-SN 1430 as illustrated and shown in any of FIGS. 3-14, respectively); or
a source SN during a SN addition procedure or a SN change procedure (e.g., S-SN 440, S-SN 540, S-SN 740, S-SN 840, S-SN 1140, S-SN 1240, S-SN 1340, or S-SN 1440 as illustrated and shown in any of FIGS. 4, 5, 7, 8, and 11-14 respectively).

Although described with respect to a RAN node, it should be understood that other devices may be configured to perform a method similar to that of FIG. 2. A source SN may also be named as S-SN, Source-SN, or the like. A target SN may also be named as T-SN, Target-SN, or the like. The embodiments of FIG. 2 assume that a UE has been configured with CPAC configuration already. Relevant RAN node(s) would like to replace (i.e., modify) the previous CPAC configuration before an execution of the CPAC procedure. The embodiments of FIG. 2 assume that a MN, a source SN, or a target SN may be combined in any one of EN-DC, NGEN-DC, NE-DC, and NR-DC scenarios.

In the exemplary method 200 as shown in FIG. 2, in operation 201, a RAN node receives configuration information relating to a CPAC procedure. The RAN node may be a MN, a S-SN, or a T-SN. In an embodiment, in a CPA procedure, a MN may transmit a Xn or X2 message including CPA related configuration information provided by the MN (e.g., the list of cells) to a T-SN, to initiate a CPA procedure. A T-SN may transmit a Xn or X2 message conveying the CPA related configuration information provided by the T-SN (e.g., RRC configuration of each cell) to a MN.

In a further embodiment, in a MN initiated inter-SN CPC procedure, a MN may transmit a Xn or X2 message including CPC related configuration information provided by the MN (e.g., the list of cells) to a T-SN, to initiate a MN initiated inter-SN CPC procedure. A T-SN may transmit a Xn or X2 message conveying the CPC related configuration information provided by the T-SN (e.g., RRC configuration of each cell) to the MN.

In an additional embodiment, in a S-SN initiated inter-SN CPC procedure, a S-SN may transmit a Xn or X2 message including CPC related configuration information provided by the S-SN (e.g., the list of cells and execution conditions) to a MN, to initiate a S-SN initiated inter-SN CPC procedure. A MN may transmit a Xn or X2 message conveying the CPC related configuration information provided by the T-SN (e.g., the list of cells) to a T-SN. Or, a T-SN may transmit a Xn or X2 message conveying the CPC related configuration information provided by the T-SN (e.g., RRC configuration of each cell) to a MN. A MN may transmit a Xn or X2 message to a S-SN including the CPC related configuration information provided by a T-SN (e.g., the list of prepared cells).

In operation 202, in response to the configuration information relating to the CPAC procedure being modified, the RAN node communicates the modified configuration information with another RAN node via a Xn interface or a X2 interface.

According to some embodiments of the exemplary method 200, the RAN node is a MN (e.g., MN 102 as illustrated and shown in FIG. 1) in a MR-DC scenario, and the abovementioned another RAN node is a target SN (e.g., SN 103 as illustrated and shown in FIG. 1) in the MR-DC scenario. According to some other embodiments of the exemplary method 200, the RAN node is a target SN in a MR-DC scenario, and the abovementioned another RAN node is a MN in the MR-DC scenario.

In some embodiments, in operation 202 of FIG. 2, the MN transmits a message to the target SN, to communicate the modified configuration information. For example, the message transmitted from the MN to the target SN may be a SN modification request message and/or a secondary gNB (SgNB) modification request message. Specific examples are described in FIGS. 3-5, 9, 11, and 13.

In an embodiment, the message transmitted from the MN to the target SN comprises at least one updated measurement result associated with at least one PSCell of the target SN. For instance, the message comprises two updated measurement results associated with two PSCells prepared by the target SN.

In a further embodiment, the message transmitted from the MN to the target SN comprises at least one of:
(1) an indicator indicating an operation to replace an existing configuration of one or more PSCells;
(2) updated configuration information relating to a primary cell (PCell) of the MN;
(3) updated configuration information relating to a PSCell of a source SN in the MR-DC scenario;
(4) a maximum number of PSCells allowed (e.g., by the MN) to be prepared by the target SN;
(5) a reference of one or more PSCells to be added, e.g., a list of PSCell(s) to be added;
(6) a reference of one or more PSCells to be modified, e.g., a list of PSCell(s) to be modified;
(7) a reference of one or more PSCells to be cancelled, e.g., a list of PSCell(s) to be cancelled;
(8) a security key to be used by the target SN; and
(9) a measurement result report related to the CPAC procedure.

In an example, if the message transmitted from the MN to the target SN includes the reference of PSCell(s) to be cancelled, the target SN cannot reject the reference of PSCell(s) to be cancelled. For instance, the target SN shall reply with an acknowledge message.

In some embodiments, in operation 202 of FIG. 2, the MN further receives a message from the target SN, to communicate the modified configuration information. For example, the message received by the MN from the target SN may be: a SN modification request acknowledge message; a SgNB modification request acknowledge message; a SN modification required message; and/or a SgNB modification required message. Specific examples are described in FIGS. 3-5, 9, 11, and 13.

In an embodiment, the message received by the MN from the target SN comprises at least one of:
(1) a maximum number of PSCells able to be prepared by the target SN; and
(2) a reference of one or more PSCells to be added, e.g., a list of PSCell(s) to be added;
(3) a reference of one or more PSCells to be modified, e.g., a list of PSCell(s) to be modified;
(4) a reference of one or more PSCells to be cancelled, e.g., a list of PSCell(s) to be cancelled; and
(5) a reference of one or more admitted PSCells, e.g., a list of PSCell(s) admitted by the target SN.

In an example, if the message received by the MN from the target SN includes the reference of PSCell(s) to be cancelled, the MN cannot reject the reference of PSCell(s) to be cancelled. For instance, the MN shall reply with an acknowledge message.

In a further embodiment, the message received by the MN from the target SN further comprises at least one of:
(1) a set of radio resource control (RRC) containers, and each PSCell in the reference of PSCell(s) to be added is associated with a RRC container in this set of RRC containers;
(2) a further set of RRC containers, and each PSCell in the reference of PSCell(s) to be modified is associated with a RRC container in this further set of RRC containers; and
(3) another set of RRC containers, and each PSCell in the reference of admitted PSCell(s) is associated with a RRC container in the abovementioned another set of RRC containers.

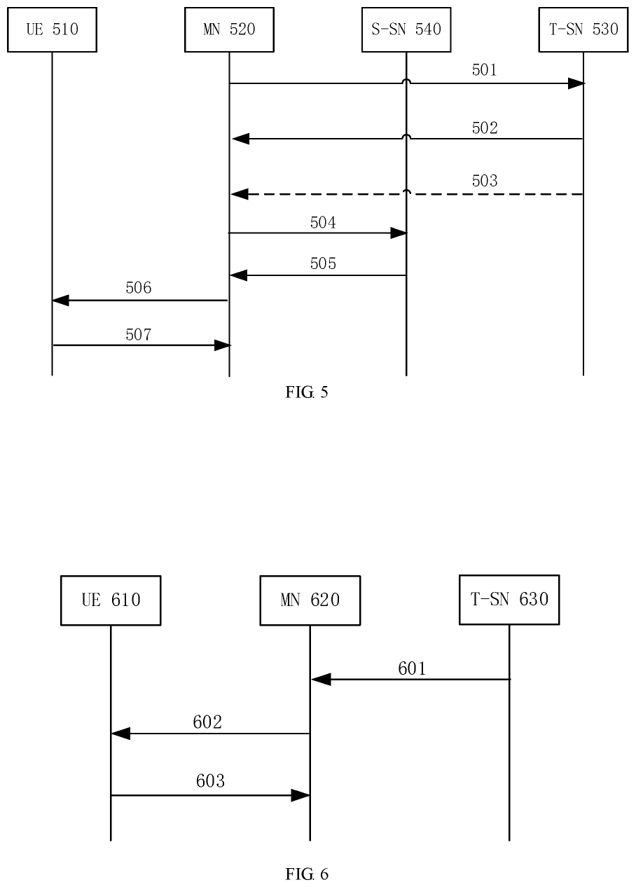

According to some embodiments, in operation 202 of FIG. 2, the MN receives a PSCell cancel message from the target SN, to communicate the modified configuration information. Specific examples are described in FIGS. 6-8. According to some other embodiments, in operation 202 of FIG. 2, the MN transmits a further PSCell cancel message to the target SN, to communicate the modified configuration information. Specific examples are described in FIGS. 10, 12, and 14.

In an embodiment, the PSCell cancel message and/or the further PSCell cancel message comprises: a reference of PSCell(s) to be cancelled; and/or an indication for PSCell(s) to be cancelled. The indication for PSCell(s) to be cancelled may be a PSCell cancel cause. In an example, the indication for PSCell(s) to be cancelled in the PSCell cancel message received by the MN from the target SN comprises at least one of:
(1) a change in CPA resource(s);
(2) a CPA replace operation in the CPAC procedure is required;
(3) a change in inter-SN CPC resource(s); and
(4) an inter-SN CPC replace operation in the CPAC procedure is required.

In a further example, the indication for PSCell(s) to be cancelled in the further PSCell cancel message transmitted from the MN to the target SN comprises: a change in resource(s) of the MN; and/or a change in resource(s) of the source SN.

According to some embodiments of the exemplary method 200, the RAN node is a source SN (e.g., SN 103 as illustrated and shown in FIG. 1) in a MR-DC scenario, and the abovementioned another RAN node is a MN (e.g., MN 102 as illustrated and shown in FIG. 1) in the MR-DC scenario. According to some other embodiments of the exemplary method 200, the RAN node is a source SN in a MR-DC scenario, and the abovementioned another RAN node is a MN in the MR-DC scenario.

In some embodiments, in operation 202 of FIG. 2, the MN transmits a message to the source SN, to communicate the modified configuration information.

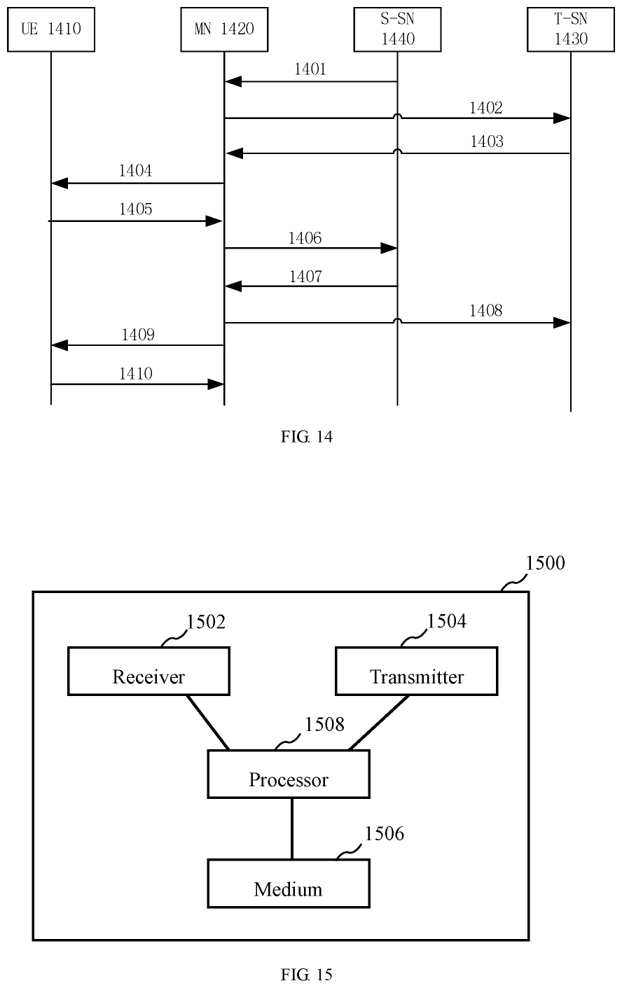

In an embodiment, the message transmitted from the MN to the source SN may be a SN change confirm message and/or a SgNB change confirm message. Specific examples are described in FIGS. 13 and 14. In an example, this message comprises: a reference of PSCell(s) prepared by the target SN; and/or a RRC container. The RRC container in the message may comprise the reference of PSCell(s) prepared by the target SN. In a further example, this message further comprises a set of RRC containers, and each PSCell in the reference of PSCell(s) prepared by the target SN is associated with a RRC container in the set of RRC containers.

In a further embodiment, the message transmitted from the MN to the source SN may be: a SN modification confirm message; a SgNB modification confirm message; SN modification request message; and/or a SgNB modification request message. A specific example is described in FIG. 13. In an example, this message transmitted from the MN to the source SN comprises at least one of:
(1) a maximum number of PSCell(s) that is able to be prepared by the target SN;
(2) a reference of PSCell(s) to be added;
(3) a reference of PSCell(s) to be modified; and
(4) a reference of PSCell(s) to be cancelled. For instance, if this message includes the reference of PSCell(s) to be cancelled, the source SN cannot reject the reference of PSCell(s) to be cancelled. That is, the source SN has to accept the reference of PSCell(s) to be cancelled. For instance, the source SN shall reply with an acknowledge message.

In a further example, this message transmitted from the MN to the source SN further comprise: (1) a set of RRC containers, and each PSCell in the reference of PSCell(s) to be added is associated with a RRC container in this set of RRC containers; and/or (2) a further set of RRC containers, and each PSCell in the reference of PSCell(s) to be modified is associated with a RRC container in this further set of RRC containers.

In some other embodiments, in operation 202 of FIG. 2, the MN further receives a message from the source SN, to communicate the modified configuration information. In an embodiment, the message received by the MN from the source SN may be: a SN modification request acknowledge message; a SgNB modification request acknowledge message; SN modification required message; and/or a SgNB modification required message. Specific examples are described in FIGS. 4, 5, 11, and 13. In a further embodiment, this message received by the MN from the source SN comprises at least one of:
(1) an indicator indicating an operation to replace an existing configuration of PSCell(s);
(2) updated configuration information relating to a PSCell of a source SN in the MR-DC scenario;
(3) a maximum number of PSCell(s) allowed (e.g., by the MN) to be prepared by the target SN;
(4) a reference of PSCell(s) to be added;
(5) a reference of PSCell(s) to be modified; and
(6) a reference of PSCell(s) to be cancelled. For instance, if this message includes the reference of PSCell(s) to be cancelled, the MN cannot reject the reference of PSCell(s) to be cancelled. That is, the MN has to accept the reference of PSCell(s) to be cancelled. For instance, the MN shall reply with an acknowledge message.

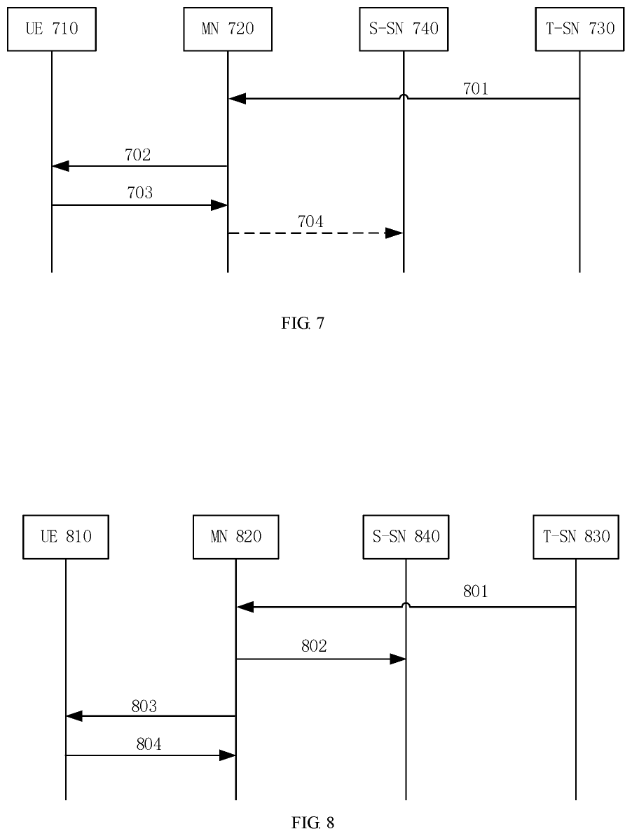

According to some embodiments, in operation 202 of FIG. 2, the MN transmits a PSCell cancel message to the source SN, to communicate the modified configuration information. Specific examples are described in FIGS. 7, 8, and 12. According to some other embodiments, in operation 202 of FIG. 2, the MN receives a further PSCell cancel message from the source SN, to communicate the modified configuration information. A specific example is described in FIG. 14.

In some embodiments, the PSCell cancel message and/or the further PSCell cancel message comprises: a reference of PSCell(s) to be cancelled; and/or an indication for PSCell(s) to be cancelled. For instance, the indication for PSCell(s) to be cancelled is a PSCell cancel cause, which indicates a cause regarding a PSCell cancel operation. In an embodiment, the indication for PSCell(s) to be cancelled in the PSCell cancel message transmitted from the MN to the source SN comprises: (1) a change in inter-SN CPC resource(s); (2) an inter-SN CPC replace operation in the CPAC procedure is required; and/or (3) a change in MN resource(s). In a further embodiment, the indication for PSCell(s) to be cancelled in the further PSCell cancel message received by the MN from the source SN comprises a change in source SN resource(s).

Details described in all other embodiments of the present application (for example, details of communicating modified configuration information regarding a CPAC procedure) are applicable for the embodiments of FIG. 2. Moreover, details described in the embodiments of FIG. 2 are applicable for all the embodiments of FIGS. 1 and 3-15.

Specifically, some embodiments of the present application provide a target SN triggered CPAC replace procedure. Specific examples are described in FIGS. 3-5 which provide SN modification based methods and FIGS. 6-8 which provide CPAC cancel based methods, respectively. These embodiments provide a CPAC replace procedure triggered by a target SN, e.g., when the target SN wants to add, remove, or modify previously configured PSCell(s). In these embodiments, the target SN triggers the CPAC replace procedure by sending a Xn message or a X2 message to a MN. In an embodiment (which is named as “Embodiment 1” hereinafter), the Xn or X2 message may contain any or a combination of following CPAC replace related information:
A maximum number of PSCell(s) that is able to be prepared by the target SN.
A list of PSCell(s) to be added, and each PSCell to be added is associated with a RRC container containing the corresponding RRC configuration.
A list of PSCell(s) to be modified, and each PSCell to be modified is associated with a RRC container containing the corresponding RRC configuration.
A list of PSCell(s) to be cancelled.

In one embodiment of these embodiments, the list of PSCell(s) to be added are selected from the list of target cells indicated by initiating node (either a MN or a SN) in the prior CPAC procedure but has not been prepared. For instance, if the initiating node (either a MN or a SN) indicates ten cells (e.g., cells 1, 2, 3, . . . and 10) as target PSCells, and the target SN has prepared five cells (e.g., cells 1, 2, 3, 4 and 5), then, the target SN may decide to prepare remaining five cells (e.g., cells 6, 7, 8, 9 and 10) as additional prepared PSCells.

In a further embodiment of these embodiments, a total number of PSCell(s) to be added is less than a difference between “a maximum number of PSCell(s) that is allowed to be prepared by the target SN (indicated by the initiating RAN node)” and “a total number of PSCell(s) that has been prepared,” i.e., a maximum number of allowed PSCell(s) minus a total number of prepared PSCell(s). For instance, if the target SN has been indicated by the MN to prepare maximum 10 PSCells, and 6 PSCells have been prepared so far. 10-6=4, and thus, 4 PSCells can be added in addition.

FIG. 3 illustrates an exemplary flowchart of a target SN triggered CPAC replace operation in a conditional PSCell addition (CPA) procedure in accordance with some embodiments of the present application.

As shown in the embodiments of FIG. 3, in operation 301, MN 320 (e.g., MN 102 as illustrated and shown in FIG. 1) transmits a Xn message or a X2 message to T-SN 330 (i.e., a target SN), to provide updated measurement result(s) associated with PSCell(s). In an embodiment, MN 320 transmits SN MODIFICATION REQUEST message via a Xn interface. In a further embodiment, MN 320 transmits SGNB MODIFICATION REQUEST message via a X2 interface. For example, the updated measurement result(s) is conveyed in a RRC container inside the Xn or X2 message, and each RRC container is associated with a concerned PSCell identity (ID).

After receiving the Xn or X2 message from MN 320, in response to the configuration information relating to the CPAC procedure being modified, T-SN 330 sends, to MN 320, a CPAC replace related message carrying CPAC replace related information as in Embodiment 1. The CPAC replace related message may be a SN MODIFICATION REQUEST ACKNOWLEDGE (Xn) message, SGNB MODIFICATION REQUEST ACKNOWLEDGE (X2) message, a SN MODIFICATION REQUIRED (Xn) message, and/or a SGNB MODIFICATION REQUIRED (X2) message.

Specifically, in operation 302, after receiving the updated PSCell measurement result(s) from MN 320, T-SN 330 might decide to add, modify, or cancel any PSCell(s) that has been prepared or to be prepared. Then, T-SN 330 might respond, to MN 320, a SN MODIFICATION REQUEST ACKNOWLEDGE message carrying the CPAC replace related information as in Embodiment 1 via a Xn interface and/or a SGNB MODIFICATION REQUEST ACKNOWLEDGE message carrying the CPAC replace related information as in Embodiment 1 via a X2 interface.

Optionally, in operation 303, after acknowledging the reception of updated PSCell measurement result(s) from MN 320, T-SN 330 might further decide to add, modify, or cancel any PSCell(s) that has been prepared or to be prepared. Then, T-SN 330 might send a SN MODIFICATION REQUIRED (Xn) message and/or a SGNB MODIFICATION REQUIRED (X2) message to carry the CPAC replace related information as in Embodiment 1.

In operation 304, MN 320 may transmit a RRC reconfiguration message to UE 310. Then, in operation 305, UE 310 may transmit a RRC reconfiguration complete message to MN 320.

Details described in all other embodiments of the present application (for example, details regarding a CPAC replace procedure) are applicable for the embodiments of FIG. 3. Moreover, details described in the embodiments of FIG. 3 are applicable for all the embodiments of FIGS. 1, 2, and 4-15.

FIG. 4 illustrates an exemplary flowchart of a target SN triggered CPAC replace operation in a MN initiated inter SN conditional PSCell change (CPC) procedure in accordance with some embodiments of the present application.

Similar to operation 301 of FIG. 3, as shown in the embodiments of FIG. 4, in operation 401, MN 420 transmits a SN MODIFICATION REQUEST (Xn) message or a SGNB MODIFICATION REQUEST (X2) message to T-SN 430, to provide updated measurement result(s) associated with PSCell(s). The updated measurement result(s) may be conveyed in a RRC container inside the Xn or X2 message, and each RRC container is associated with a concerned PSCell ID.

Similar to the embodiments of FIG. 3, in the embodiments of FIG. 4, T-SN 430 may communicate CPAC replace related information as in Embodiment 1 with MN 420, e.g., in a SN MODIFICATION REQUEST ACKNOWLEDGE (Xn) message, SGNB MODIFICATION REQUEST ACKNOWLEDGE (X2) message, a SN MODIFICATION REQUIRED (Xn) message, and/or a SGNB MODIFICATION REQUIRED (X2) message.

Specifically, in operation 402, after receiving the updated PSCell measurement result(s) from MN 420, T-SN 430 might decide to add, modify, or cancel any PSCell(s) that has been prepared or to be prepared. Then, T-SN 430 might respond a SN MODIFICATION REQUEST ACKNOWLEDGE (Xn) message and/or a SGNB MODIFICATION REQUEST ACKNOWLEDGE (X2) message carrying the CPAC replace related information as in Embodiment 1.

Optionally, in operation 403, after acknowledging the reception of updated PSCell measurement result(s) from MN 420, T-SN 430 might further decide to add, modify, or cancel any PSCell(s) that has been prepared or to be prepared. Then, T-SN 430 might send a SN MODIFICATION REQUIRED (Xn) message and/or a SGNB MODIFICATION REQUIRED (X2) message to carry the CPAC replace related information as in Embodiment 1.

Similar to operations 304 and 305 of FIG. 3, in operation 404, MN 420 may transmit a RRC reconfiguration message to UE 410. Then, in operation 405, UE 410 may transmit a RRC reconfiguration complete message to MN 420.

In operation 406, MN 420 may transmit a SN MODIFICATION CONFIRM message to T-SN 430.

In a MN initiated inter-SN CPC procedure as shown in the embodiments of FIG. 4, upon confirming the SN modification regarding a CPAC replace procedure (i.e., sending a SN modification confirm (Xn) message to T-SN 430 in operation 406), MN 420 may also inform S-SN 440 about the CPAC replace procedure by sending a Xn message containing the CPAC replace related information as in Embodiment 1. The Xn message can be the existing SN MODIFICATION REQUEST message or a new Xn message.

According to some embodiments, if the existing SN MODIFICATION REQUEST message is used to inform a source SN about the CPAC replace procedure. An additional indicator may be added to the SN modification request message, so that S-SN 440 can understand that the CPAC replace procedure is for a MN initiated inter-SN CPC procedure. S-SN 440 shall not reject the SN modification request message in such case, and S-SN 440 shall reply with a SN modification acknowledge message.

According to some embodiments, if a new Xn message is used to inform S-SN 440 about the CPAC replace procedure for a MN initiated CPC procedure, the new Xn message is a one-directional message which does not require any acknowledge feedback from S-SN 440.

Referring back to FIG. 4, optionally, in operation 407, MN 420 may transmit a SN MODIFICATION REQUEST message to S-SN 440. Optionally, in operation 408, S-SN 440 may transmit a SN MODIFICATION REQUEST ACKNOWLEDGE message to MN 420.

Details described in all other embodiments of the present application (for example, details regarding a CPAC replace procedure) are applicable for the embodiments of FIG. 4. Moreover, details described in the embodiments of FIG. 4 are applicable for all the embodiments of FIGS. 1-3 and 5-15.

FIG. 5 illustrates an exemplary flowchart of a target SN triggered CPAC replace operation in a SN initiated CPC procedure in accordance with some embodiments of the present application.

Similar to operation 301 of FIG. 3 as well as operation 401 of FIG. 4, in operation 501 as shown in the embodiments of FIG. 5, MN 520 transmits a SN MODIFICATION REQUEST (Xn) message or a SGNB MODIFICATION REQUEST (X2) message to T-SN 530, to provide updated measurement result(s) associated with PSCell(s).

Similar to operations 302 and 303 of FIG. 3 as well as operations 402 and 403 of FIG. 4, in operations 502 and 503 as shown in the embodiments of FIG. 5, T-SN 530 may communicate CPAC replace related information as in Embodiment 1 with MN 520, e.g., in a SN MODIFICATION REQUEST ACKNOWLEDGE (Xn) message, SGNB MODIFICATION REQUEST ACKNOWLEDGE (X2) message, a SN MODIFICATION REQUIRED (Xn) message, and/or a SGNB MODIFICATION REQUIRED (X2) message.

In some embodiments of FIG. 5, if the CPAC replace is for a SN initiated CPC, upon receiving the SN modification required message from T-SN 530 for a CPAC replace operation, MN 520 forwards the CPAC replace request to S-SN 540 via a SN modification request Xn message. The SN modification request message may contain CPAC related information as in Embodiment 1. S-SN 540 may approve the CPAC replace by replying a SN modification request acknowledge message.

In particular, in operation 504, MN 520 may transmit a SN MODIFICATION REQUEST message to S-SN 540. In operation 505, S-SN 540 may transmit a SN MODIFICATION REQUEST ACKNOWLEDGE message to MN 520.

Similar to operations 304 and 305 of FIG. 3 as well as operations 404 and 405 of FIG. 4, in operations 506 and 507 as shown in the embodiments of FIG. 5, a RRC reconfiguration message and a RRC reconfiguration complete message may be communicated between MN 520 and UE 510.

Details described in all other embodiments of the present application (for example, details regarding a CPAC replace procedure) are applicable for the embodiments of FIG. 5. Moreover, details described in the embodiments of FIG. 5 are applicable for all the embodiments of FIGS. 1-4 and 6-15.

FIG. 6 illustrates a further flowchart of a target SN triggered CPAC replace operation in a CPA procedure based on a PSCell cancel message in accordance with some embodiments of the present application.

As shown in the embodiments of FIG. 6, T-SN 630 triggers a CPAC replace procedure by sending a PSCell cancel message to MN 620 via a Xn or X2 interface. The PSCell cancel message between a MN and a target SN may be named as a cancel PSCell message, a T-SN CPAC cancel message, a CPAC cancel message, a cancel CPAC message, or the like.

In particular, in operation 601, T-SN 630 transmits a PSCell cancel message to MN 620, to communicate CPAC replace related information. The PSCell cancel message does not request a feedback or an acknowledge message from MN 620. In an embodiment (which is named as “Embodiment 2” hereinafter), the PSCell cancel message may contain any or a combination of following CPAC replace related information:
List of PSCell(s) to be cancelled.
Cause(s). The cause(s) may be related to a PSCell cancel cause, which indicates a cause regarding a PSCell cancel operation. For example, the cause(s) may be “a change of CPA resource(s),” “a CPA replace procedure is required,” “an inter-SN CPC resources change,” and/or “an inter-SN CPC replace procedure is required.”

Similar to the embodiments of FIGS. 3-5, in operations 602 and 603 as shown in the embodiments of FIG. 6, a RRC reconfiguration message and a RRC reconfiguration complete message may be communicated between MN 620 and UE 610.

Details described in all other embodiments of the present application (for example, details regarding a CPAC replace procedure) are applicable for the embodiments of FIG. 6. Moreover, details described in the embodiments of FIG. 6 are applicable for all the embodiments of FIGS. 1-5 and 7-15.

FIG. 7 illustrates an exemplary flowchart of a target SN triggered CPAC replace operation in a MN initiated CPC procedure based on a PSCell cancel message in accordance with some embodiments of the present application.

Similar to the embodiments of FIG. 6, in operation 701 as shown in the embodiments of FIG. 7, T-SN 730 transmits a PSCell cancel message (e.g., a T-SN CPAC cancel message) to MN 720, to communicate CPAC replace related information as in Embodiment 2. Similar to the embodiments of FIGS. 3-6, in operations 702 and 703 as shown in the embodiments of FIG. 7, a RRC reconfiguration message and a RRC reconfiguration complete message may be communicated between MN 720 and UE 710.

In some embodiments, in a case of a MN initiated CPC procedure, after receiving the T-SN CPAC cancel message from T-SN 730, MN 720 might inform S-SN 740 about the CPAC cancel operation by sending a CPC cancel message to S-SN 740 via a Xn or X2 interface. In particular, optionally, in operation 704, MN 720 transmits a further PSCell cancel message to S-SN 740. The further PSCell cancel message between a MN and a source SN may be named as a MN CPC cancel message, a MN CPC PSCell cancel message, a CPC cancel message, a cancel CPC message, or the like.

In an embodiment, the MN CPC cancel message sent from MN 720 to S-SN 740 via a Xn or X2 interface is a one-directional message which does not request a feedback or an acknowledgement from S-SN 740. The MN CPC cancel message may contain any or a combination of the following information:
List of PSCell(s) to be cancelled.
Cause(s). The cause(s) may be related to a PSCell cancel cause, which indicates a cause regarding a PSCell cancel operation. For instance, the cause(s) may be “an inter-SN CPC resources change” and/or “an inter-SN CPC replace is required.”

Details described in all other embodiments of the present application (for example, details regarding a CPAC replace procedure) are applicable for the embodiments of FIG. 7. Moreover, details described in the embodiments of FIG. 7 are applicable for all the embodiments of FIGS. 1-6 and 8-15.

FIG. 8 illustrates an exemplary flowchart of a target SN triggered CPAC replace operation in a SN initiated CPC procedure based on a PSCell cancel message in accordance with some embodiments of the present application.

Similar to the embodiments of FIGS. 6 and 7, in operation 801 as shown in the embodiments of FIG. 8, T-SN 830 transmits a PSCell cancel message (e.g., a T-SN CPAC cancel message) to MN 820, to communicate CPAC replace related information as in Embodiment 2.

In some embodiments, in a case of a SN initiated CPC procedure, after receiving the T-SN CPAC cancel message from T-SN 830, MN 820 shall inform S-SN 840 about the CPAC cancel operation by sending a MN CPC cancel message to S-SN 840 via a Xn or X2 interface. In particular, in operation 802, MN 820 transmits a further PSCell cancel message to S-SN 840. The further PSCell cancel message between a MN and a source SN may be named as a MN CPC cancel message, a MN CPC PSCell cancel message, a CPC cancel message, a cancel CPC message, or the like. In an embodiment, the MN CPC cancel message sent from MN 820 to S-SN 840 is a one-directional message which does not request a feedback or an acknowledgement from S-SN 840. The MN CPC cancel message may contain any or a combination of the following information: a list of PSCell(s) to be cancelled; and PSCell cancel cause(s), which indicates a cause(s) regarding a PSCell cancel operation. For instance, the cause(s) may be “an inter-SN CPC resources change” and/or “an inter-SN CPC replace is required.”

After transmitting the MN CPC cancel message sent from MN 820 to S-SN 840 in operation 802, in operations 803 and 804 as shown in the embodiments of FIG. 8, a RRC reconfiguration message and a RRC reconfiguration complete message may be communicated between MN 820 and UE 810, which are similar to the embodiments of FIGS. 3-7.

Details described in all other embodiments of the present application (for example, details regarding a CPAC replace procedure) are applicable for the embodiments of FIG. 8. Moreover, details described in the embodiments of FIG. 8 are applicable for all the embodiments of FIGS. 1-7 and 9-15.

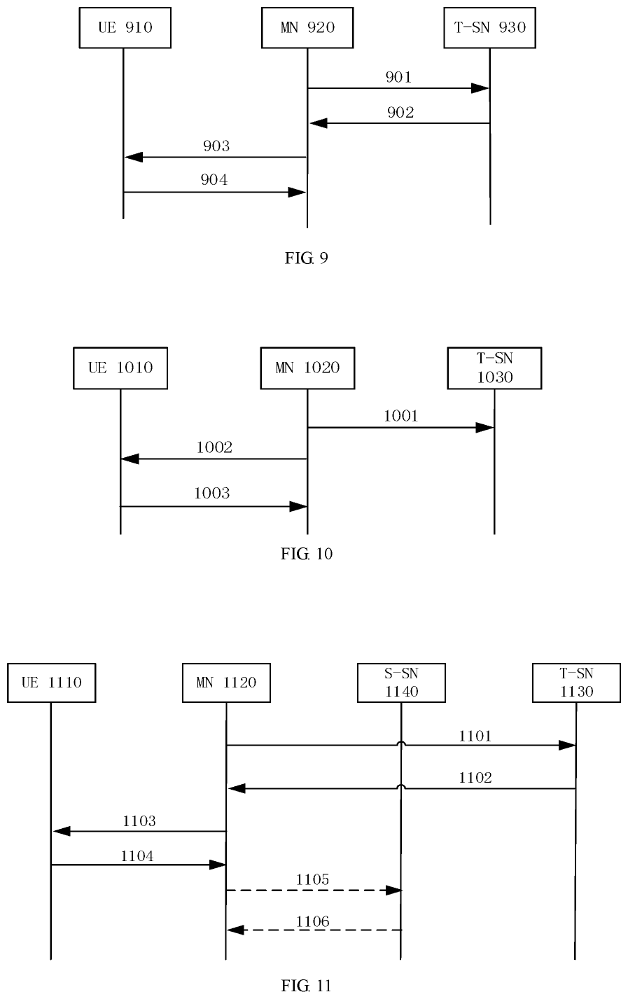

Some embodiments of the present application provide a MN triggered CPAC replace procedure. Specific examples are described in FIGS. 9-12, respectively. These embodiments provide a CPAC replace procedure triggered by a MN by sending a SN MODIFICATION REQUEST (Xn) message, a SGNB MODIFICATION REQUEST (X2) message, or a MN CPAC cancel message (Xn or X2) message to the target SN. In an embodiment (which is named as “Embodiment 3” hereinafter), the SN MODIFICATION REQUEST (Xn) message or a SGNB MODIFICATION REQUEST (X2) message may contain any or a combination of following CPAC replace related information:
Indicator of a CPAC replace procedure. The indicator may be named as a CPAC replace indicator or the like. For instance, the indicator indicates an operation to replace an existing configuration of PSCell(s).
Change in configuration information related to PCell(s) of a MN (e.g., carried in a MN RRC container).
Change in configuration information related to PSCell(s) of a source SN (e.g., carried in a MN RRC container).
Maximum number of PSCell(s) that is allowed to be prepared by a target SN.
List of PSCell(s) to be added.
List of PSCell(s) to be modified.
List of PSCell(s) to be cancelled.
Security key to be used by the target SN.
Measurement result report related to a CPAC procedure. In an example, measurement result(s) in the measurement result report is beam-level measurement result(s). For instance, a MN informs a target SN for “a CPAC replace procedure” based on the measurement result(s). Then, the target SN will prepare the corresponding new CPAC procedure. The beam-level measurement result(s) should be included. The target SN can configure suitable RACH resource(s) associated with suitable downlink (DL) beam(s).

FIG. 9 illustrates an exemplary flowchart of a MN triggered CPAC replace operation in a CPA procedure based on a SN modification request message in accordance with some embodiments of the present application.

As shown in the embodiments of FIG. 9, in operation 901, MN 920 communicate CPAC replace related information as in Embodiment 3 with T-SN 930, e.g., in a SN MODIFICATION REQUEST message via a Xn interface, and/or a SGNB MODIFICATION REQUEST message via a X2 interface.

According to some embodiments, MN 920 sending the Xn or X2 message in operation 901 could be caused by receiving a T-SN CPAC cancel message from T-SN 930 as described in any of the embodiments of FIGS. 6-8 and requesting a CPAC replace procedure. In this case, an explicit CPAC replace indicator is needed in the SN MODIFICATION REQUEST (Xn) message and/or the SGNB MODIFICATION REQUEST (X2) message.

After receiving the Xn or X2 message from MN 920 in operation 901, in operation 902, T-SN 930 could response a SN MODIFICATION REQUEST ACKNOWLEDGE message via a Xn interface and/or a SCG MODIFICATION REQUEST ACKNOWLEDGE message via a X2 interface. According to some embodiments, the message transmitted in operation 902 may contain any or a combination of the following CPAC replace related information:
List of PSCell(s) admitted (e.g., by T-SN 930). Each admitted PSCell in the list of PSCell(s) is associated with a RRC container containing the corresponding RRC configuration.
Maximum number of PSCell(s) that is able to be prepared by T-SN 930.

Similar to the embodiments of FIGS. 3-8, in operations 903 and 904 as shown in the embodiments of FIG. 9, a RRC reconfiguration message and a RRC reconfiguration complete message may be communicated between MN 920 and UE 910.

Details described in all other embodiments of the present application (for example, details regarding a CPAC replace procedure) are applicable for the embodiments of FIG. 9. Moreover, details described in the embodiments of FIG. 9 are applicable for all the embodiments of FIGS. 1-8 and 10-15.

FIG. 10 illustrates a further flowchart of a MN triggered CPAC replace operation in a CPA procedure based on a PSCell cancel message in accordance with some embodiments of the present application.

As shown in the embodiments of FIG. 10, in operation 1001, MN 1020 transmits trigger a CPAC replace procedure by sending a PSCell cancel message (e.g., a MN CPAC cancel message) to T-SN 1030 via a Xn or X2 interface. The MN CPAC cancel message does not request any feedback or acknowledgement from T-SN 1030. For instance, the MN CPAC cancel message may contain: a list of PSCell(s) to be cancelled; and/or cause(s). The cause(s) may be related to a PSCell cancel cause, which indicates a cause regarding a PSCell cancel operation. For example, the cause(s) may be a change in MN resource(s).

Similar to the embodiments of FIGS. 3-9, in operations 1002 and 1003 as shown in the embodiments of FIG. 10, a RRC reconfiguration message and a RRC reconfiguration complete message may be communicated between MN 1020 and UE 1010.

Details described in all other embodiments of the present application (for example, details regarding a CPAC replace procedure) are applicable for the embodiments of FIG. 10. Moreover, details described in the embodiments of FIG. 10 are applicable for all the embodiments of FIGS. 1-9 and 11-15.

FIG. 11 illustrates an exemplary flowchart of a MN triggered CPAC replace operation in a MN initiated CPC procedure based on a SN modification request message in accordance with some embodiments of the present application.

Similar to operation 901 of FIG. 9, in operation 1101 as shown in the embodiments of FIG. 11, MN 1220 transmits CPAC replace related information as in Embodiment 3 to T-SN 1130, e.g., in a SN MODIFICATION REQUEST (Xn) message, and/or SGNB MODIFICATION REQUEST (X2) message.

Similar to operation 902 of FIG. 9, in operation 1102 as shown in the embodiments of FIG. 11, after receiving the message from MN 1120 in operation 1101, T-SN 1130 could response a SN MODIFICATION REQUEST ACKNOWLEDGE (Xn) message and/or a SCG MODIFICATION REQUEST ACKNOWLEDGE (X2) message.

Similar to operations 903 and 904 of FIG. 9, in operations 1103 and 1104 as shown in the embodiments of FIG. 11, a RRC reconfiguration message and a RRC reconfiguration complete message may be communicated between MN 1120 and UE 1110.

According to some embodiments, after receiving the SN MODIFICATION REQUEST ACKNOWLEDGE (Xn) message or the SCG MODIFICATION REQUEST ACKNOWLEDGE (X2) message from T-SN 1130, optionally, MN 1120 may inform S-SN 1140 about the CPAC replace procedure by sending a Xn message containing the CPAC replace related information as in Embodiment 1. The Xn message can be the existing SN MODIFICATION REQUEST message or a new Xn message.

In an embodiment, if the existing SN MODIFICATION REQUEST message is used to inform S-SN 1140 about the CPAC replace procedure, an additional indicator may be added in the SN MODIFICATION REQUEST message, so that S-SN 1140 can understand that the CPAC replace procedure is for a MN 1120 initiated inter-SN CPC procedure. S-SN 1140 shall not reject the SN MODIFICATION REQUEST message in such embodiment, which means that S-SN 1140 shall reply with a SN MODIFICATION REQUEST ACKNOWLEDGE message.

In particular, referring back to FIG. 11, optionally, in operation 1105, MN 1120 may transmit a SN MODIFICATION REQUEST message to S-SN 1140.

Optionally, in operation 1106, S-SN 1140 may transmit a SN MODIFICATION REQUEST ACKNOWLEDGE message to MN 1120.

In a further embodiment, if a new Xn message is used to inform S-SN 1140 about the CPAC replace procedure for a MN 1120 initiated CPC procedure, the Xn message is a one-directional message which does not require any feedback or acknowledgement from S-SN 1140.

Details described in all other embodiments of the present application (for example, details regarding a CPAC replace procedure) are applicable for the embodiments of FIG. 11. Moreover, details described in the embodiments of FIG. 11 are applicable for all the embodiments of FIGS. 1-10 and 12-15.

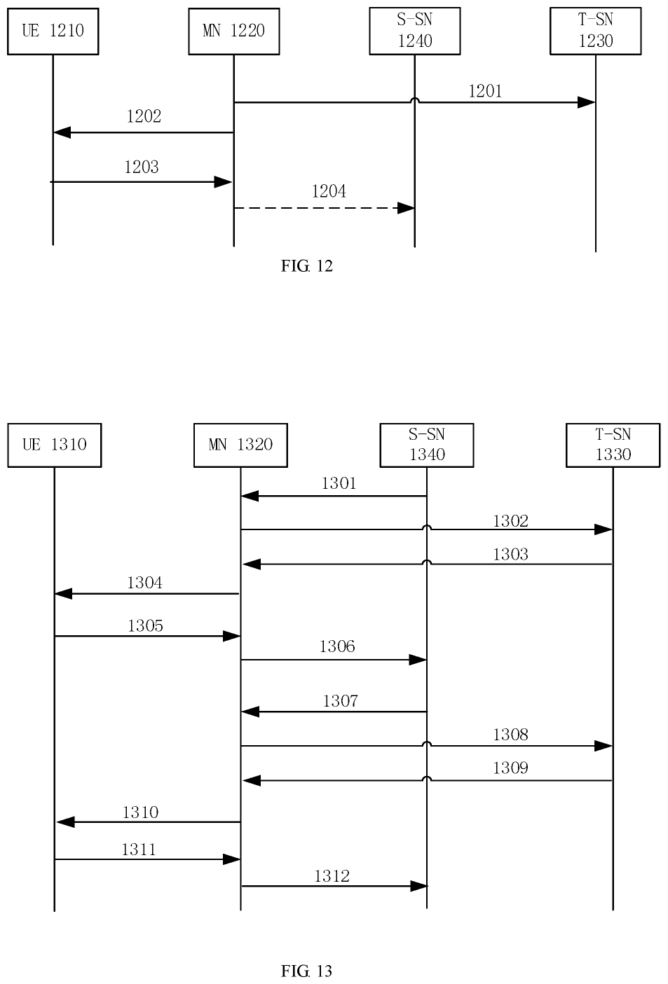

FIG. 12 illustrates a further flowchart of a MN triggered CPAC replace operation in a MN initiated CPC procedure based on a PSCell cancel message in accordance with some embodiments of the present application.

Similar to operation 1001 of FIG. 10, in operation 1201 as shown in the embodiments of FIG. 12, MN 1220 transmits a PSCell cancel message (e.g., a MN CPAC cancel message) to T-SN 1230. The MN CPAC cancel message does not request any feedback or acknowledgement from T-SN 1230. The MN CPAC cancel message may contain: a list of PSCell(s) to be cancelled, and/or PSCell cancel cause(s). For example, the PSCell cancel cause(s) is a change in resource(s) of MN 1220.

Similar to the embodiments of FIG. 10, in operations 1202 and 1203 as shown in the embodiments of FIG. 12, a RRC reconfiguration message and a RRC reconfiguration complete message may be communicated between MN 1220 and UE 1210.

According to some embodiments, optionally, in operation 1204, after MN 1220 informs T-SN 1230 about the CPAC cancel operation, MN 1220 might also inform S-SN 1240 by sending a MN CPC cancel message to S-SN 1240 via a Xn or X2 interface. The MN CPC cancel message may contain: a list of PSCells to be cancelled; and/or PSCell cancel cause(s). The cause(s) may be a change in resource(s) of MN 1220.

Details described in all other embodiments of the present application (for example, details regarding a CPAC replace procedure) are applicable for the embodiments of FIG. 12. Moreover, details described in the embodiments of FIG. 12 are applicable for all the embodiments of FIGS. 1-11 and 13-15.

Some embodiments of the present application provide a source SN triggered CPAC replace procedure. Specific examples are described in FIGS. 13 and 14, respectively. These embodiments provide a CPAC replace procedure triggered by a source SN by sending, to a MN, a SN MODIFICATION REQUIRED (Xn) message, a SGNB MODIFICATION REQUIRED (X2) message, SN CHANGE REQUIRED (Xn) message, SGNB CHANGE REQUIRED (X2) message, and/or a S-SN cancel message.

FIG. 13 illustrates an exemplary flowchart of a source SN triggered CPAC replace operation in a SN initiated CPC procedure based on a SN modification request message in accordance with some embodiments of the present application.

As shown in the embodiments of FIG. 13, in operation 1301, S-SN 1340 transmits a SN change required message to MN 1320. In operation 1302, MN 1320 transmits a SN addition request message to T-SN 1330. In operation 1303, T-SN 1330 transmits a SN addition request acknowledge message to MN 1320. In operation 1304, MN 1320 transmits a RRC reconfiguration message to UE 1310. Then, in operation 1305, UE 1310 transmits a RRC reconfiguration complete message to MN 1320.

In some embodiments of the present application, during a source SN triggered CPAC replace procedure, a source SN may be informed with a list of prepared PSCell(s) by a target SN by a SN change confirm message sent from a MN. The SN change confirm message may contain the list of prepared PSCell(s). The list of prepared PSCell(s) can be information element(s) of a Xn or X2 message, or be contained in a RRC container (e.g., inside a SN RRC reconfiguration complete message). When the list of PSCell(s) is provided as information element(s) of the Xn or X2 message, each PSCell may be associated with its relevant RRC configuration information (i.e., a RRC container).

With reference to FIG. 3, in operation 1306, MN 1320 may transmit a SN change confirm message to S-SN 1340, to inform a list of PSCell(s) prepared by T-SN 1330.

In operation 1307, S-SN 1340 may transmit a SN MODIFICATION REQUIRED (Xn) message, a SGNB MODIFICATION REQUIRED (X2) message, a SN CHANGE REQUIRED (Xn) message, and/or a SGNB CHANGE REQUIRED (X2) message to MN 1320. In some embodiments, the message transmitted in operation 1307 contains any or a combination of following CPAC replace related information:
(1) Indicator of a CPAC replace procedure, i.e., a CPAC replace indicator.
(2) Change in configuration information related to PSCell(s) of S-SN 1340 (e.g., carried in a MN RRC container).
(3) Maximum number of PSCell(s) that is allowed to be prepared by T-SN 1330.
(4) A list of PSCell(s) to be added.
(5) A list of PSCell(s) to be modified.
(6) A list of PSCell(s) to be cancelled.

According to some embodiments, S-SN 1340 sending the message in operation 1307 could be caused by receiving a MN CPC replace message from MN 1320 as described in any of the embodiments of FIGS. 3-5 and requesting a CPC replace procedure. In this case, an explicit CPAC replace indicator may be needed.

In operation 1308, upon receiving the Xn or X2 message from S-SN 1340, MN 1320 informs T-SN 1330 about the CPC procedure triggered by S-SN 1340 using a SN MODIFICATION REQUEST (Xn) message and/or SGNB MODIFICATION REQUEST (X2) message. The message sent from MN 1320 to T-SN 1330 contains any or a combination of following CPAC replace related information:
(1) Indicator of CPAC replace, i.e., a CPAC replace indicator.
(2) Change in configuration information related to PCell(s) of MN 1320 (e.g., carried in a MN RRC container).
(3) Change in configuration information related to PSCell(s) of S-SN 1340 (e.g., carried in a MN RRC container).
(4) Maximum number of PSCell(s) that is allowed to be prepared by T-SN 1330.
(5) A list of PSCell(s) to be added.
(6) A list of PSCell(s) to be modified.
(7) A list of PSCell(s) to be cancelled.
(8) Security key to be used by T-SN 1330.
(9) Measurement result report related to a CPAC procedure. In an example, measurement result(s) in the measurement result report is beam-level measurement result(s). For instance, MN 1320 informs T-SN 1330 for “a CPAC replace procedure” based on the measurement result(s). Then, T-SN 1330 will prepare the corresponding new CPAC procedure. The beam-level measurement result(s) should be included. T-SN 1330 can configure suitable RACH resource(s) associated with suitable downlink (DL) beam(s).

In operation 1309, after receiving the message from MN 1320 in operation 1308, T-SN 1330 could response a SN MODIFICATION REQUEST ACKNOWLEDGE (Xn) message and/or SCG MODIFICATION REQUEST ACKNOWLEDGE (X2) message. The message transmitted in operation 1309 may contain any or a combination of following CPAC replace related information:
(1) A list of admitted PSCell(s), and each admitted PSCell is associated with a RRC container containing the corresponding RRC configuration.
(2) Maximum number of PSCell(s) that is able to be prepared by T-SN 1330.

Similar to the embodiments of FIG. 12, in operations 1310 and 1311 as shown in the embodiments of FIG. 13, a RRC reconfiguration message and a RRC reconfiguration complete message may be communicated between MN 1320 and UE 1310.

According to some embodiments, upon receiving the Xn message from T-SN 1330 (e.g., a SN modification request acknowledge), MN 1320 knows that the S-SN 1340 triggered CPC replace procedure is successful. Then, MN 1320 may inform S-SN 1340 about the updated prepared PSCell list by sending a message including the CPAC replace related information as in Embodiment 1. For example, in operation 1309, MN 1320 transmits a SN CHANGE CONFIRM (Xn) message, a SGNB CHANGE CONFIRM (X2) message, a SN MODIFICATION CONFIRM (Xn) message, and/or a SGNB CHANGE CONFIRM (X2) message to S-SN 1340, to communicate the CPAC replace related information as in Embodiment 1.

Details described in all other embodiments of the present application (for example, details regarding a CPAC replace procedure) are applicable for the embodiments of FIG. 13. Moreover, details described in the embodiments of FIG. 13 are applicable for all the embodiments of FIGS. 1-12, 14, and 15.

FIG. 14 illustrates a further exemplary flowchart of a source SN triggered CPAC replace operation in a SN initiated CPC procedure based on a PSCell cancel message in accordance with some embodiments of the present application.

As shown in the embodiments of FIG. 14, operations 1401 to 1406 performed by UE 1410, MN 1420, S-SN 1440, and T-SN 1430 are the same as operations 1301 to 1306 performed by UE 1310, MN 1320, S-SN 1340, and T-SN 1330 as shown in the embodiments of FIG. 13.

According to some embodiments, S-SN 1440 could trigger a CPAC replace procedure by sending a PSCell cancel message to T-SN 1430 via a Xn or X2 interface. In operation 1407, S-SN 1440 transmits a PSCell cancel message (e.g., a S-SN CPC cancel message) to MN 1420. The S-SN CPC cancel message does not request any feedback or acknowledgement from MN 1420. The S-SN CPC cancel message may contain any or a combination of following CPAC replace related information: a list of PSCell(s) to be cancelled; and/or cause(s) which may be related to a PSCell cancel cause. The cause(s) may be a change in resource(s) of S-SN 1440.

According to some embodiments, after MN 1420 receives the S-SN CPC cancel message from S-SN 1440, MN 1420 may inform T-SN 1430 about the CPAC cancel operation by sending a further PSCell cancel message to T-SN 1430 via a Xn or X2 interface. In operation 1408, MN 1420 transmits a further PSCell cancel message (e.g., a MN CPAC cancel message) to T-SN 1430. The MN CPC cancel message may contain: a list of PSCell(s) to be cancelled; and/or cause(s) which may be related to a PSCell cancel cause. The cause(s) may be a change in resource(s) of S-SN 1440.

In operation 1409 as shown in the embodiments of FIG. 14, MN 1420 may further transmit a RRC reconfiguration message to UE 1410. Then, in operation 1410, UE 1410 may transmit a RRC reconfiguration complete message to MN 1420.

Details described in all other embodiments of the present application (for example, details regarding a CPAC replace procedure) are applicable for the embodiments of FIG. 14. Moreover, details described in the embodiments of FIG. 14 are applicable for all the embodiments of FIGS. 1-13 and 15.

FIG. 15 illustrates an exemplary block diagram of an apparatus according to some embodiments of the present application. In some embodiments of the present application, the apparatus 1500 may be a RAN node (e.g., a MN, a source SN, or a target SN), which can at least perform the method illustrated in any of FIGS. 2-14.

As shown in FIG. 15, the apparatus 1500 may include at least one receiver 1502, at least one transmitter 1504, at least one non-transitory computer-readable medium 1506, and at least one processor 1508 coupled to the at least one receiver 1502, the at least one transmitter 1504, and the at least one non-transitory computer-readable medium 1506.

Although in FIG. 15, elements such as the at least one receiver 1502, the at least one transmitter 1504, the at least one non-transitory computer-readable medium 1506, and the at least one processor 1508 are described in the singular, the plural is contemplated unless limitation to the singular is explicitly stated. In certain embodiments of the present application, the apparatus 1500 may further include an input device, a memory, and/or other components.

In some embodiments of the present application, the at least one receiver 1502 and the at least one transmitter 1504 are combined into a single device, such as a transceiver, for example, a wireless radio transceiver coupled to the at least one processor 1508. The wireless radio transceiver may be configured to at least perform the method illustrated in any of FIGS. 2-14.

In some embodiments of the present application, the at least one non-transitory computer-readable medium 1506 may have stored thereon computer-executable instructions which are programmed to implement the operations of the methods, for example as described in view of any of FIGS. 2-14, with the at least one receiver 1502, the at least one transmitter 1504, and the at least one processor 1508.

Those having ordinary skills in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

1. A method performed by a first radio access network (RAN) node, the method comprising:
receiving configuration information relating to a conditional primary cell of a secondary cell group (PSCell) addition and change (CPAC) procedure; and
in response to the configuration information relating to the CPAC procedure being modified, communicating the modified configuration information with a second RAN node via a Xn interface or a X2 interface.

2. The method of claim 1, wherein:
the first RAN node is a master node (MN) in a multi-radio dual connectivity (MR-DC) scenario, and the second RAN node is a target secondary node (SN) in the MR-DC scenario; or
the first RAN node is the target SN in the MR-DC scenario, and the second RAN node is the MN in the MR-DC scenario.

3. The method of claim 2, wherein communicating the modified configuration information further comprises transmitting a first message from the MN to the target SN, and wherein the first message is at least one of:
a SN modification request message; and
a secondary gNB (SgNB) modification request message.

4. The method of claim 3, wherein the first message comprises:
an indicator indicating an operation to replace an existing configuration of one or more PSCells;
updated configuration information relating to a primary cell (PCell) of the MN;
updated configuration information relating to a PSCell of a source SN in the MR-DC scenario;
a maximum number of PSCells allowed to be prepared by the target SN;
a reference of one or more PSCells to be added;
a reference of one or more PSCells to be modified;
a reference of one or more PSCells to be cancelled;
a security key to be used by the target SN;
a measurement report related to the CPAC procedure; or
a combination thereof.

5. The method of claim 3, wherein communicating the modified configuration information further comprises receiving, by the MN, a second message from the target SN, and wherein the second message comprises:
a SN modification request acknowledge message;
a SgNB modification request acknowledge message;
a SN modification required message;
a SgNB modification required message; or
a combination thereof.

6. The method of claim 5, wherein the second message comprises:
a maximum number of PSCells able to be prepared by the target SN; and
a first reference of one or more PSCells to be added;
a second reference of one or more PSCells to be modified;
a third reference of one or more PSCells to be cancelled;
a fourth reference of one or more admitted PSCells; or
a combination thereof.

7. The method of claim 2, wherein communicating the modified configuration information further comprises receiving, by the MN, a first PSCell cancel message from the target SN.

8. The method of claim 2, communicating the modified configuration information further comprises transmitting a second PSCell cancel message from the MN to the target SN.

9. The method of claim 1, wherein:
the first RAN node is a source secondary node (SN) in a multi-radio dual connectivity (MR-DC) scenario, and the second RAN node is a master node (MN) in the MR-DC scenario; or
the first RAN node is the MN in the MR-DC scenario, and the second RAN node is the source SN in the MR-DC scenario.

10. The method of claim 9, wherein communicating the modified configuration information further comprises transmitting a third message from the MN to the source SN.

11. The method of claim 10, wherein the third message comprises:
a SN change confirm message;
a secondary gNB (SgNB) change confirm message; or
a combination thereof.

12. The method of claim 11, wherein the third message comprises:
a reference of one or more PSCells prepared by a target SN;
a radio resource control (RRC) container, wherein the RRC container comprises the reference of one or more PSCells prepared by the target SN; or
a combination thereof.

13. The method of claim 9, wherein communicating the modified configuration information further comprises transmitting a third PSCell cancel message from the MN to the source SN.

14. The method of claim 9, communicating the modified configuration information further comprises receiving, by the MN, a fourth PSCell cancel message from the source SN.

15. An apparatus for performing a network function, the apparatus comprising:
at least one memory; and
at least one processor coupled with the at least one memory and configured to cause the apparatus to:
receive configuration information relating to a conditional primary cell of a secondary cell group (PSCell) addition and change (CPAC) procedure; and
in response to the configuration information relating to the CPAC procedure being modified, communicate the modified configuration information with a second radio access network (RAN) node via a Xn interface or a X2 interface.

16. The apparatus of claim 15, wherein:
a first RAN node is a master node (MN) in a multi-radio dual connectivity (MR-DC) scenario, and the second RAN node is a target secondary node (SN) in the MR-DC scenario; or
the first RAN node is the target SN in the MR-DC scenario, and the second RAN node is the MN in the MR-DC scenario.

17. The apparatus of claim 16, wherein communicating the modified configuration information further comprises transmitting a first message from the MN to the target SN, and wherein the first message comprises:
a SN modification request message;
a secondary gNB (SgNB) modification request message; or
a combination thereof.

18. The apparatus of claim 17, wherein the first message comprises:
an indicator indicating an operation to replace an existing configuration of one or more PSCells;
updated configuration information relating to a primary cell (PCell) of the MN;
updated configuration information relating to a PSCell of a source SN in the MR-DC scenario;
a maximum number of PSCells allowed to be prepared by the target SN;
a reference of one or more PSCells to be added;
a reference of one or more PSCells to be modified;
a reference of one or more PSCells to be cancelled;
a security key to be used by the target SN;
a measurement report related to the CPAC procedure; or
a combination thereof.

19. The apparatus of claim 17, wherein communicating the modified configuration information further comprises receiving, by the MN, a second message from the target SN, and wherein the second message comprises:
a SN modification request acknowledge message;
a SgNB modification request acknowledge message;
a SN modification required message;
a SgNB modification required message; or
a combination thereof.

20. The apparatus of claim 19, wherein the second message comprises:
a maximum number of PSCells able to be prepared by the target SN; and
a first reference of one or more PSCells to be added;
a second reference of one or more PSCells to be modified;
a third reference of one or more PSCells to be cancelled;
a fourth reference of one or more admitted PSCells; or
a combination thereof.
